(19) United States
(12) Patent Application Publication
(10) Pub. No.: US 2014/0369451 A1
(43) Pub. Date: Dec. 18, 2014

(54) DIRECT SAMPLING RECEIVER WITH CONTINUOUS-TIME MDAC

(71) Applicant: Broadcom Corporation, Irvine, CA (US)

(72) Inventors: Jiangfeng Wu, Irvine, CA (US); Binning Chen, Irvine, CA (US)

(21) Appl. No.: 13/930,573

(22) Filed: Jun. 28, 2013

Related U.S. Application Data
(60) Provisional application No. 61/836,469, filed on Jun. 18, 2013.

(51) Int. Cl. H04L 25/08

(52) U.S. Cl. CPC H04L 25/08
USPC 375/349

(57) ABSTRACT

Methods and apparatuses are described for a direct sampling receiver having high dynamic range and low noise figure with a continuous-time (CT) multiplying digital-to-analog converter (MDAC) architecture. In a multipath architecture, the input signal is sampled in the quantizer path, but not the CT signal path. In the CT signal path, only a filtered residue signal is sampled. Coarse bits generated in the quantizer path and fine bits generated in the input signal path are digitally combined to reconstruct the analog input signal in the digital domain. Filtering, aperture error control and digital equalization remove sources of errors, resulting in high performance. Advantages include toleration of multiple blocker signals, simultaneous reception of multiple weak channels and/or strong and weak channels, operation with simplified gain control and reduced pre-amplification as well as operation without excessive power consumption, external filters and tunable local oscillator (LO).

### CROSS-REFERENCE TO RELATED APPLICATIONS

This application claims the benefit of U.S. Provisional Application No. 61/836,469, filed Jun. 18, 2013, the entirety of which is hereby incorporated by reference herein.

### BACKGROUND

1. Technical Field

The subject matter described herein relates to communication receivers. In particular, the subject matter described herein relates to receivers having a high dynamic range analog-to-digital converter (ADC) architecture with a continuous-time (CT) multiplying digital to analog converter (MDAC).

2. Description of Related Art

Wideband and narrowband receivers are generally required to have high dynamic range (i.e., ability to handle a wide range of signal strengths) to receive weak signals in an environment with strong blocker signals (blockers). A first problem is that wideband (e.g., multi-channel or multi-carrier) receivers generally comprise multiple narrowband receivers, which leads to multiplication of power and area consumption and a necessity for external passive filters. A second problem is that filters and other blocker cancellation techniques used by receivers are not effective to handle multiple blockers or wideband blockers for multi-channel or multi-carrier signals.

A third problem is that higher performing ADCs (analog-to-digital converters) consume excessive power. The dynamic range of a receiver is often limited by its ADC. ADC dynamic range is limited by thermal noise power (i.e., kT/C) and sampling nonlinearity. The resolution quality of a recovered signal is often specified by an effective number of bits (ENOB), which is the number of bits representing a signal, excluding the number of bits representing noise. In order to achieve a high ENOB (e.g., signal resolution in excess of 12 bits) at high speed, ADCs consume excessive power to overcome increasing noise accompanying increasing speed.

State of the art ADC architectures do not support a direct sampling receiver with high speed (e.g., multi GHz), high dynamic range (e.g., greater than 70 dB), high resolution (e.g., greater than 11 bit ENOB), low noise figure (NF) (e.g., lower than 20 dB) without pre-amplification, with reduced area, power consumption and cost, suitable for a wide variety of applications, e.g., full-band, narrow-band, multi-channel and single-channel, in a wide variety of communication markets, e.g., terrestrial TV, cable, satellite, multi-media over coax alliance (MoCA), uWave, WiFi, WiMax and cellular communications.

### BRIEF SUMMARY

Methods, systems, and apparatuses are described for a direct sampling receiver that includes a CT MDAC, substantially as shown in and/or described herein in connection with at least one of the figures, as set forth more completely in the claims.

### BRIEF DESCRIPTION OF THE DRAWINGS/FIGURES

The accompanying drawings, which are incorporated herein and form a part of the specification, illustrate a plurality of embodiments and, together with the description, further serve to explain the principles involved and to enable a person skilled in the pertinent art(s) to make and use the disclosed technologies. However, embodiments of the disclosed technologies are not limited to the specific implementations disclosed herein. Unless expressly indicated by common numbering, each figure represents a different embodiment where components and steps in each embodiment are intentionally numbered differently.

FIG. 1 shows a block diagram of an exemplary embodiment of a communication system with a direct sampling receiver with a CT MDAC.

FIGS. 2 and 3 show block diagrams of exemplary embodiments of direct sampling receivers with CT MDACs.

FIG. 4 shows an output spectrum for the exemplary CT MDAC embodiment shown in FIG. 2 in response to a weak signal at 600 MHz and a +60 dB blocker at 850 MHz.

FIG. 5 shows an output spectrum for the exemplary CT MDAC embodiment with aperture error control and equalization shown in FIG. 3 in response to a weak signal at 600 MHz and a +60 dB blocker at 850 MHz.

FIG. 6 shows a flowchart of an exemplary embodiment of a process for converting an analog signal into a digital signal in a direct sampling receiver with a CT MDAC.

FIG. 7 shows a flowchart of an exemplary embodiment of a process for converting an analog signal into a digital signal in a direct sampling receiver with a CT MDAC.

Embodiments will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

Reference will now be made to embodiments that incorporate features of the described and claimed subject matter, examples of which are illustrated in the accompanying drawings. While the technology will be described in conjunction with various embodiments, it will be understood that the embodiments are not intended to limit the present technology. The scope of the subject matter is not limited to the disclosed embodiment(s). On the contrary, the present technology is intended to cover alternatives, modifications, and equivalents, which may be included within the spirit and scope the various embodiments as defined herein, including by the appended claims. In addition, in the following detailed description, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the embodiments presented.

References in the specification to “embodiment,” “example” or the like indicate that the subject matter described may include a particular feature, structure, characteristic, or step. However, other embodiments do not necessarily include the particular feature, structure, characteristic or step. Moreover, “embodiment,” “example” or the like do not necessarily refer to the same embodiment. Further, when a particular feature, structure, characteristic or step is described in connection with an embodiment, it is submitted that it is within the knowledge of one skilled in the art to effect such feature, structure, or characteristic in connection with other embodiments whether or not those other embodiments are explicitly described.

Certain terms are used throughout the following description and claims to refer to particular system components and configurations. As one skilled in the art will appreciate, various skilled artisans and companies may refer to a component by different names. The discussion of embodiments is not intended to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection or through an indirect electrical connection via other devices and connections.

Methods and apparatuses are described for a multi-GHz direct sampling receiver having high dynamic range (e.g., over 70 dB) and low noise figure (e.g., under 20 dB) with a continuous-time (CT) multiplying digital-to-analog converter (MDAC) architecture. Difficulties in a wideband, high speed and strong blocker environment are overcome by a multipath architecture where the input signal is sampled in the quantizer path, but not the signal path. In the signal path, only a filtered residue signal is sampled. Coarse bits generated in the quantizer path and fine bits generated in the input signal path are digitally combined to reconstruct the analog input signal in the digital domain. Filtering, aperture error control and digital equalization remove sources of errors, resulting in high performance. Advantages include toleration of multiple blocker signals, simultaneous reception of multiple weak channels and/or strong and weak channels, operation with simplified gain control and reduced pre-amplification as well as operation without excessive power consumption, external filters and tunable local oscillator (LO).

Methods, systems, and apparatuses will now be described for a direct sampling receiver with CT MDAC architecture having high speed, high dynamic range and low noise figure. Many embodiments of systems, devices and methods may be implemented, each with various configurations and/or steps. While several detailed features and embodiments are discussed below, many more embodiments are possible. In Section II, an exemplary communication system is described. In Section III, an exemplary direct sampling receiver with CT MDAC architecture is described. In Section IV, exemplary spectrums of a direct sampling receiver with CT MDAC Architecture are described. In Section V, an exemplary method of analog to digital conversion by an exemplary CT MDAC architecture is described.

### II. Exemplary Communication System and CT MDAC Embodiments

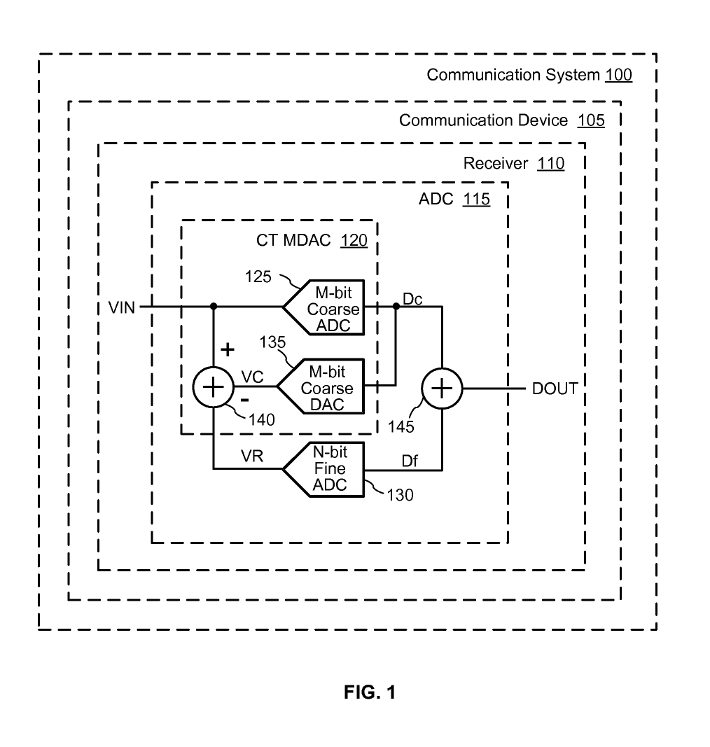

FIG. 1 shows a block diagram of an exemplary embodiment of a communication system having a direct sampling receiver with a CT MDAC. Specifically, communication system 100 comprises communication device 105 that includes a receiver 110. Receiver 110 includes an analog-to-digital converter (ADC) 115 that includes a continuous-time (CT) multiplying digital-to-analog converter (MDAC) 120.

Communication system 100 may be any wired and/or wireless communication system, including, but not limited to, terrestrial TV (television), cable, satellite, multi-media over coax alliance (MoCA), uWave, WiFi, WiMax and cellular communication systems. Communication device 105 may be any wired or wireless communication device, including, but not limited to, a TV or satellite set top box, cellular telephone (e.g., a smart phone), a transceiver, an access point, a router, a modem, and/or other type of communication device. Receiver 110 may be a standalone receiver or a receiver in any communication device or system having a CT MDAC. ADC 115 may be a standalone ADC or an ADC in any receiver, device or system having a CT MDAC.

CT MDAC 120 is illustrated with a simplified block diagram representative of many possible embodiments having one or more CT MDACs. CT MDAC 120 has multiple signal paths, e.g., a quantizer path 150 and a continuous-time (CT) path 155. Each signal path may include one or more electrical conductors (e.g., metal traces or other types of electrical conductors), as well as the respective components described herein and/or further or alternative components. CT MDAC 120 comprises an M-bit coarse ADC 125, an M-bit coarse DAC 135, and a residue calculator 140. CT MDAC based ADC 115 comprises a CT MDAC 120, an N-bit fine ADC 130, and a digital combiner 145. M-bit coarse ADC 125 and N-bit fine ADC 130 have heterogeneous sampling, i.e., they do not sample the same signal and may not have the same sampling rates and phases. M-bit coarse ADC 125 samples an analog input signal VIN 160 in quantizer path 150 while N-bit fine ADC 130 samples an analog residue signal VR, instead of input signal VIN 160, in CT path 155. M-bit coarse ADC 125 generates an M coarse bits Dc while N-bit fine ADC generates an N fine bits Df, with both M coarse bits Dc and N fine bits Df being digital signals. M-bit coarse DAC 135 converts M coarse bits Dc into a coarse analog signal VC. Residue calculator 140 subtracts coarse analog signal VC from analog input signal VIN 160 to generate analog residue signal VR. Digital combiner 145 digitally combines M coarse bits Dc and N fine bits Df to generate digital output DOUT 165, which is a digital representation of analog input signal VIN 160.

The following section describes example embodiments for CT MDAC 120

III. Exemplary Direct Sampling Receiver with CT MDAC Architecture

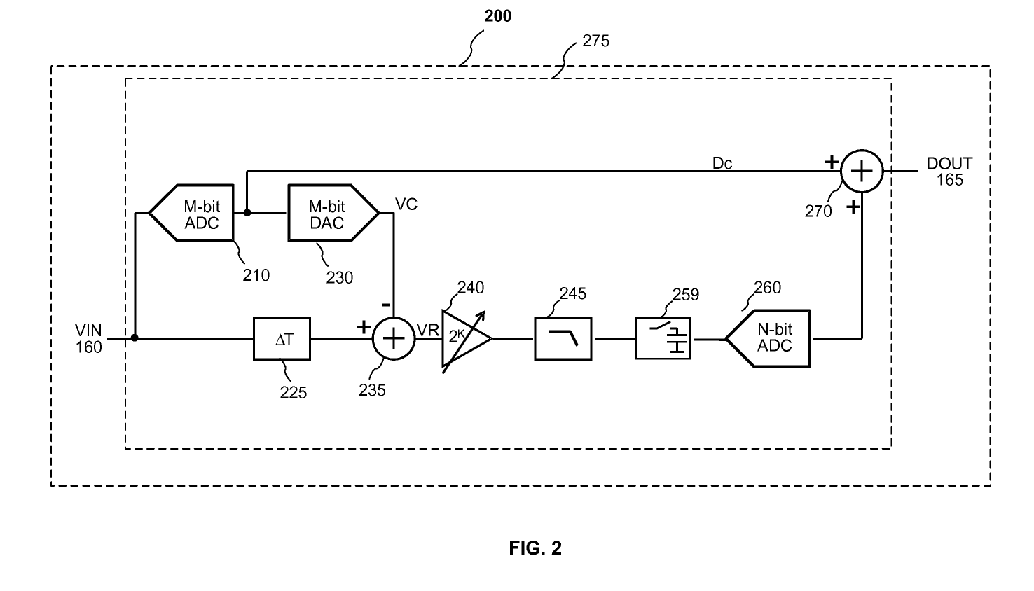

As one of many examples of receiver topology in which embodiments may be implemented, FIG. 2 shows a block diagram of an exemplary embodiment of a direct sampling receiver 200 that includes a CT MDAC 275. Receiver 200 is an example of receiver 110, and CT MDAC 275 is an example of CT MDAC 120, of FIG. 1. In the embodiment shown in FIG. 2, CT MDAC 275 comprises, from left to right, top to bottom, M-bit ADC 210, delay (ΔT) 225, M-bit DAC 230, residue calculator 235, amplifier 240, and filter 245. Direct sampling receiver 200, also referred to as CT MDAC based receiver 200, comprises CT MDAC 275, sampler 259, N-bit ADC 260, and digital combiner 270. Receiver 200 may also be an ADC. The embodiment shown in FIG. 2 is one of many embodiments. Other embodiments may have fewer or additional components. Exemplary features of CT MDAC based direct sampling receiver 200 are described as follows.

Generally, CT MDAC based receiver 200 comprises a multi-path ADC with a quantizer path through M-bit ADC 210 and a continuous time path through N-bit ADC. The paths take heterogeneous samples where the quantizer path samples input signal VIN 160 at M-bit ADC 210 and the CT path (or signal path) samples a residue signal portion of input signal VIN 160, which is determined by residue calculator 235, at N-bit ADC 260. Input signal VIN 160 is not sampled on the CT path. In some embodiments, receiver 200 may comprise one of multiple channels in a multi-channel time-interleaved ADC. An ultra-high speed ADC, e.g., 10 GS/s (giga-samples per second), may be realized by a multi-channel or time-interleaved ADC. It must be understood that the embodiment shown in FIG. 2 is just one of many embodiments. Many other embodiments may have fewer components, more components and different components, other than those shown in FIG. 2.

More specifically, M-bit ADC 210 provides coarse quantization by converting a portion of analog input signal VIN 160 into M coarse bits Dc. In other words, M-bit ADC 210 may be considered to digitize a portion of input signal VIN 160, or to digitize input signal VIN 160 into a coarse or low resolution form. Coarse bits or M-bits are the M more significant bits (MSBs) that represent analog input signal VIN 160 in the digital domain with low resolution. In some embodiments, the sampling time of M-bit ADC 210 may be adjusted. Coarse quantization bits Dc, which includes a number M of bits in each sample, are provided to digital combiner 270. M-bit DAC 230 converts coarse quantization Dc to analog form to generate coarse analog signal VC.

In parallel with the operation of M-bit ADC 210, and M-bit DAC 230, delay 225 delays input signal VIN 160 to output a delayed version of input signal VIN 160. In the analog domain, residue calculator 235 determines residue input signal VR by subtracting coarse analog signal VC and noise PN from the delayed input signal VIN 160. Amplifier 240 amplifies residue signal VR with a gain of 2^{K} (e.g., when k is 3, amplifier 240 provides a gain of 8). In some embodiments, K may be less than M. There is a greater tolerance for inaccuracy by M-bit ADC 210 so long as K is less than M. When K is less than M, redundancy or overranging is provided to tolerate errors by M-bit ADC 210. In some embodiments, the gain of amplifier 240 may be variable.

Filter 245 receives the amplified residue signal VR from amplifier 240, and filters noise and distortion from the amplified residue signal. Sampler 259 and N-bit ADC 260 receive and digitize the amplified and filtered residue signal, including noise (if present), into N fine bits Df. Fine bits or N-bits are the N less significant bits (LSBs) that represent analog input signal VIN 160 in the digital domain with high resolution. In some embodiments, digital equalizer 365 may correct amplitude and phase frequency in N fine bits Df.

Digital combiner 270 receives and combines M coarse bits Dc and N fine bits Df, and subtracts noise PN (when present), to generate digital output DOUT 165, which is a digital representation of analog input signal VIN 160. For instance, digital combiner 270 may create each digital output value (e.g., a bit string) in a stream of digital output values that represent DOUT 165 by using M coarse bits Dc as the MSBs of the digital sample, and N fine bits Df as the LSBs of the digital sample, to create the digital output value to have a bit length of M+N.

In some embodiments, M may be in the range of four to six, such that M-bit ADC 210 is a 4-bit to 6-bit ADC, providing MSBs or lower resolution. In some embodiments, N may be in the range of eight to ten, such that N-bit ADC 260 is an 8-bit to 10-bit ADC, providing LSBs or higher resolution. In other embodiments, M and N may be any number of bits. The sampling rates of M-bit ADC 210, M-bit DAC 230 and N-bit ADC 260 may be the same or different. For example, in some embodiments, the sampling rate of M-bit ADC 210 and M-bit DAC 230 may be twice the sampling rate of N-bit ADC 260 in order to obtain higher residue signal gain and to simplify delay 225.

In some embodiments, M-bit ADC 210 and/or N-bit ADC 260 may comprise high speed flash ADCs with very small quantizer delays. M-bit DAC 230 may comprise a high speed current or resistor DAC. High speed ADCs and DAC provide very low latency.

In some embodiments, delay 225 may be a fixed analog delay. The delay may vary with process, voltage, and/or temperature (PVT). In other embodiments, delay 225 may be a variable, controllable, delay. Delay 225 may comprise a 1^{st} or 2^{nd} order low-pass or all-pass filter with non-ideal group delay, which, in at least some embodiments, need not be accurate or flat.

In some embodiments, filter 245 may comprise a 1^{st} or second order low-pass, anti-aliasing filter. In some embodiments, amplifier 240 and filter 245 may be combined into one block. In other embodiments, amplifier 240, filter 245 and sampler 259 may be combined into one block Output linearity of amplifier 240 need not exceed the linearity requirement of N-bit ADC 260.

In some embodiments, delay mismatch in the quantizer and CT paths, the frequency responses of amplifier 240 and filter 245, PVT variations and/or other issues may necessitate corrective circuitry. A primary challenge for CT MDAC architecture is the aperture error between the quantizer path and CT path. The aperture error may cause over-ranging in N-bit ADC 260. Delay 225 may reduce the error. A flash ADC with a very low quantizer delay implemented as M-bit ADC 210 may also reduce the error.

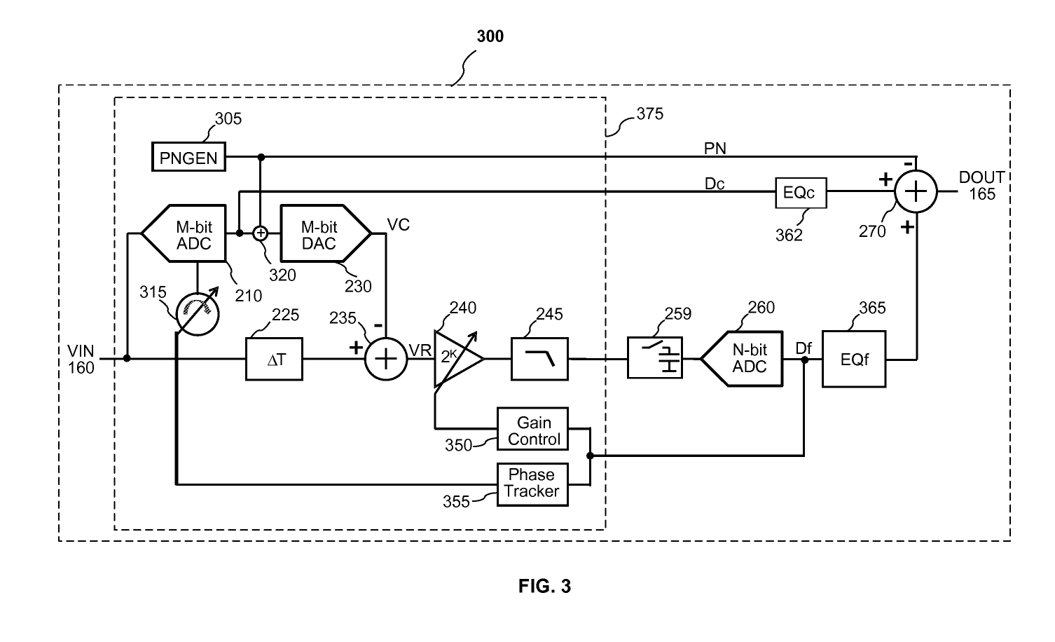

As one of many examples of receiver topology in which embodiments may be implemented, FIG. 3 shows a block diagram of an exemplary embodiment of a direct sampling receiver 300 that includes a CT MDAC 375 and corrective circuitry. Receiver 300 is an example of receiver 200, and CT MDAC 375 is an example of CT MDAC 275, of FIG. 2. CT MDAC 375 is generally the same as CT MDAC 275, with the addition of a pseudo random noise generator (PNGEN) 305, a phase rotator 315, a noise injector 320, a gain control 350, a phase tracker 355, a coarse equalizer EQc 362, and a fine equalizer EQ 365. The above description of receiver 200 applies to the description of receiver 300, with additional description provided as follows.

Note that some embodiments may comprise corrective or compensating circuitry while others may not. FIG. 3 illustrates several types of corrective circuitry. Some embodiments may implement all, some or none of this corrective circuitry and/or may implement other corrective circuitry. Corrective circuitry illustrated in FIG. 3 includes phase tracker 355, phase rotator 315, gain control 350, fine equalizer EQ 365, PNGEN 305 and noise injector 320. As described herein, any one or more of the corrective circuitry elements illustrated in FIG. 3 may be incorporated in receiver 200 of FIG. 2.

A digital phase/delay tracking/control loop may be present to adjust the sampling time of M-bit ADC 210 in order to minimize an input power to N-bit ADC 260 that increases with aperture error. Accordingly, phase rotator 315 and phase tracker 355 may be present. In this embodiment, the digital phase tracking loop comprises phase tracker 355 coupled to N fine bits Df and phase rotator 315 coupled to M-bit ADC 210. Other embodiments may implement no phase tracking loop or a different phase tracking loop. Phase rotator 315 may be provided with a clock input from a phase-locked loop (PLL) (not shown). Phase rotator 315 generates a sampling clock for M-bit ADC 210. Phase tracker 355 may provide a timing recovery signal to phase rotator 315 to cause phase rotator 315 to adjust the sampling clock phase.

A digital gain control loop may be present to track PVT gain variation and adjust the gain of amplifier 240 in the CT path. Accordingly, gain control 350 may be present. Gain control 350 may generate and provide a gain control signal to amplifier 240, which adjusts gain according to the gain control signal. In this embodiment, the gain control loop comprises gain control 350 coupled to N fine bits Df and amplifier 240. Other embodiments may implement no gain control loop or a different gain control loop. In such embodiments, gain control 350 may not be present.

Digital correction of the amplitude and phase responses of M-bit DAC 230, residue calculator 235, amplifier 240 and filter 245 may be provided by digital equalizers and background calibration. For instance, digital equalization may be applied to M coarse bits Dc and N fine bits Df before digital combiner 270. In such an embodiment, digital coarse equalizer EQc 362 and fine equalizer EQf 365 may be present to provide equalization and calibration may be provided by PNGEN 305. In the embodiment of FIG. 3, coarse equalizer EQc 362 is coupled to the output of M-bit ADC 210 and to an input of digital combiner 270 while fine equalizer EQf 365 is coupled to the output of N-bit ADC 260 and to an input of digital combiner 270. PNGEN 305 is coupled to an input of noise injector 320 and to an input of digital combiner 270. Coarse equalizer EQc corrects amplitude and phase frequency responses in M coarse bits Dc to improve the accuracy of digital combination. Fine equalizer EQf 365 corrects amplitude and phase frequency responses in the CT path to improve the accuracy of digital combination. Fine equalizer EQf 365 may comprise a finite impulse response (FIR) filter or infinite impulse response (IIR) filter. Equalization may be performed on fine data, coarse data, or both. Accordingly, PNGEN 305 may generate fine noise, coarse noise, or both.

PNGEN 305 and noise injector 230 may be present in some embodiments. In this embodiment, prior to providing coarse quantization bits Dc to M-bit DAC 230, noise injector 320 may be present to inject noise PN (“pseudo noise” or “pseudo random noise”) generated by PNGEN 305. PNGEN 305 may provide background calibration. In order to calibrate equalizer 365, PNGEN generates noise PN that is injected (by noise injector 320) into M coarse bits Dc before M-bit DAC 230 converts M coarse bits Dc into coarse analog signal VC used by residue calculator 235 to calculate residue signal VR. Noise PN characterizes CT MDAC amplitude and phase frequency responses. PNGEN 305 tracks variations in the amplitude and phase frequency responses due to PVT and due to the phase and gain loops. Noise PN is digitally injected, converted to analog by M-bit DAC 230 and re-digitized by N-bit ADC 260. This permits equalizer 365 to be calibrated by operation of PNGEN 305.

There are numerous advantages to the CT MDAC architectures described herein. Because strong blockers dominate coarse quantization, the strong blockers are removed from residue signal VR in the quantizer path, and residue signal VR may include the desired signal. By removing any strong blockers, increased gain may be applied to residue signal VR to amplify the weak desired signal before sampling by N-bit ADC 260. The increased signal gain improves the signal-to-noise ratio (SNR).

Noise and distortion caused by M-bit ADC 210 do not significantly impact overall performance because M coarse bits Dc, which drive the conversion by M-bit DAC 230, are known during reconstruction, i.e., during digital combination.

Due to low pass filtering of residue signal VR by filter 245 before sampling by sampler 259 and N-bit ADC 260, SNR is not limited by kT/C noise. SNR is limited by K+N bits, and typically may be less than K+N bits. Noise, high-frequency transients and images introduced by M-bit DAC 230, residue calculator 235 and amplifier 240 are reduced by filter 245.

Due to gain provided to residue signal VR by amplifier 240 before sampling by sampler 259 and N-bit ADC 260, the effective number of bits (ENOB) is not limited by sampling nonlinearity.

While M-bit DAC 230 should have low noise, its integral non-linearity (INL) can be calibrated. The gain error, nonlinearity and frequency response of M-bit DAC 230 may be estimated by a PN sequence and compensated during reconstruction performed by equalizer 365.

Furthermore, an inaccuracy of amplifier 240 can be tolerated. The gain error, nonlinearity and frequency response of amplifier 240 may be estimated by a PN sequence, and compensated for during reconstruction performed by equalizer 365. In this manner, AGC (automatic gain control) may be simplified.

A single, robust direct sampling receiver with a CT MDAC ADC tolerates multiple blocker signals, simultaneously receives multiple weak and/or strong signals and tolerates substantial inaccuracy, requiring only N-bit sampling linearity, while providing higher dynamic range, higher bandwidth, lower power, lower area and lower cost than state of the art Multi-GHz high resolution receivers and ADCs. ENOB requirement for ADCs may be reduced. Less pre-amplification is necessary. External passive filters are unnecessary. An ADC having an M-bit ADC and an N-bit ADC is much easier to implement and consumes much less total power than an M+N−1 bit ADC. Multi-GHz ADCs with ENOB greater than 11 bits may be practically implemented. High dynamic range, full band, single-channel and multi-channel communication systems and receivers with NF (noise figure) less than 20 dB may be practically implemented with simplified gain control and reduced pre-amplification without excessive power consumption, external filters and tunable local oscillator (LO). This enables full band communication systems in previously difficult to impossible systems, such as terrestrial TV and cellular communications.

The following section provides some example output spectrums for CT MDAC embodiments for some example analog input signals.

IV. Exemplary Spectrum of Direct Sampling Receiver with CT MDAC Architecture

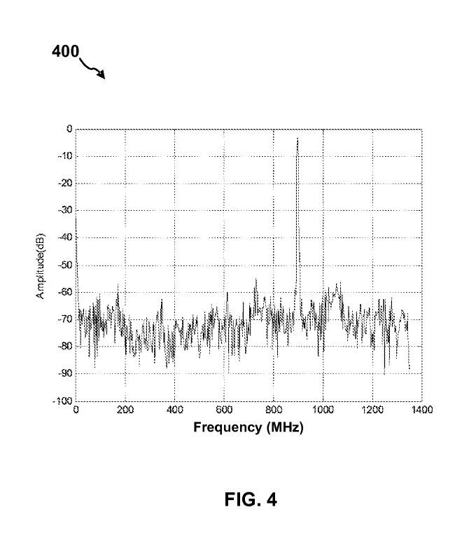

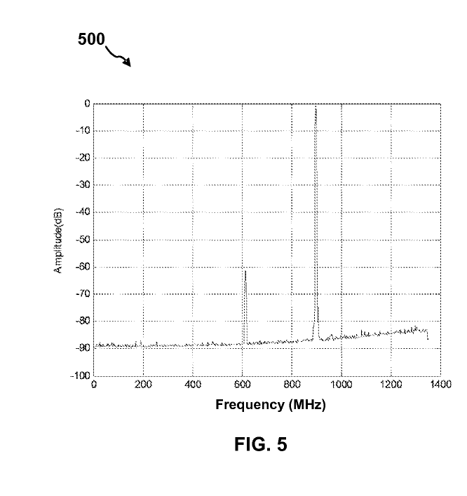

FIGS. 4-5 show output frequency spectrums for the exemplary CT MDAC embodiment shown in FIG. 2 and FIG. 3, where M is 6, N is 10, K is 2, delay 225 comprises a 2^{nd} order Bessel filter having a non-ideal group delay and operational speed is 2.7 GS/s. In each of FIGS. 4-5, amplitude (in dB) is indicated on the Y-axis, and frequency (in MHz) is indicated on the X-axis. In each case, a single continuous wave (CW) tone at 850 MHz is applied in input signal VIN 160 (850 MHz is the highest terrestrial frequency). Furthermore, in each of FIGS. 4-5, the output frequency spectrum is shown for digital output DOUT 165. Aperture error control is provided by phase tracker 355 and equalization is provided by equalizer 365.

FIG. 4 shows an output spectrum 400 for the exemplary CT MDAC embodiment shown in FIG. 2 without corrective circuitry in response to a weak signal at 600 MHz (e.g., a desired signal) and a +60 dB blocker at 850 MHz (e.g., a blocker signal) applied as input signal VIN 160. FIG. 4 shows digital output DOUT 165 showing the weak desired signal at 600 MHz is buried under noise and distortion.

FIG. 5 shows an output spectrum 500 for the exemplary CT MDAC embodiment with aperture error control and equalization shown in FIG. 3 in response to a weak signal at 600 MHz (e.g., a desired signal) and a +60 dB blocker at 850 MHz (e.g., a blocker signal) applied as input signal VIN 160. FIG. 5 shows digital output DOUT 165 including the weak desired signal at 600 MHz and the +60 dB blocker signal at 850 MHz with low noise. Compared to output spectrum 400 in FIG. 4, the noise and distortion are reduced by aperture error control and equalization, allowing the weak desired signal at 600 MHz to be detected.

The following section shows further example CT MDAC operational embodiments.

### VI. Exemplary Method

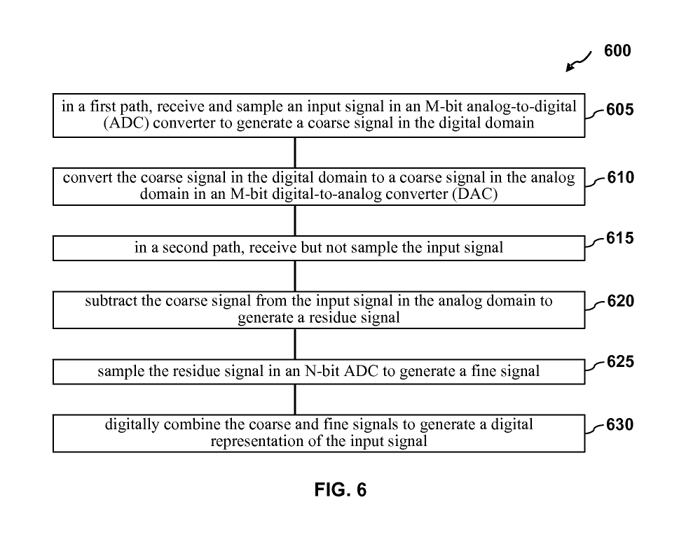

Embodiments may also be implemented in processes or methods. For example, FIG. 6 shows a flowchart 600 of an exemplary embodiment for a process of converting an analog signal into a digital signal in a direct sampling receiver with a CT MDAC. Embodiments described with respect to FIGS. 1-5 and/or otherwise in accordance with the technical subject matter described herein may operate according to flowchart 600. Flowchart 600 comprises steps 605 to 630 that may be performed in a continuous operation. However, embodiments may operate in other ways. No order of steps is required unless expressly indicated or inherently required. There is no requirement that a method embodiment implement all of the steps illustrated in FIG. 6. FIG. 6 is simply one of many possible embodiments. Embodiments may implement fewer, more or different steps. Other structural and operational embodiments will be apparent to persons skilled in the relevant art(s) based on the description of flowchart 600. Flowchart 600 is described as follows.

Flowchart 600 begins with step 605. In step 605, in a first path an input signal is received and sampled in an M-bit analog-to-digital (ADC) converter to generate a coarse signal in the digital domain. For example, as shown in FIGS. 1 and 2, in the quantizer path, input signal VIN 160 may be sampled by M-bit coarse ADC 125 or M-bit ADC 210 to generate M coarse bits Dc.

At step 610, the coarse signal in the digital domain is converted to a coarse signal in the analog domain in an M-bit digital-to-analog converter (DAC). For example, as shown in FIGS. 1 and 2, in the quantizer path M coarse bits Dc is converted into coarse analog signal VC by M-bit coarse DAC 135 or M-bit DAC 230.

At step 615, in a second path, the input signal is received but not sampled. For example, as shown in FIGS. 1 and 2, input signal VIN 160 is received in the CT path (e.g., is received by calculator 140 in FIG. 1; is received and delayed by delay 225, and the delayed version is received by calculator 235 in FIG. 2), but is not sampled.

At step 620, the coarse analog signal is subtracted from the input signal in the analog domain to generate a residue signal. For example, as shown in FIGS. 1 and 2, residue signal calculator 140 and 235 subtract coarse analog signal VC from input signal VIN 160 to generate residue signal VR.

At step 625, the residue signal is sampled in an N-bit ADC to generate a fine signal. For example, as shown in FIGS. 1 and 2, N-bit fine ADC 130 and N-bit ADC 260 sample residue signal VR to generate N fine bits Df.

At step 630, the coarse and fine signals are digitally combined to generate a digital representation of the input signal. For example, as shown in FIGS. 1 and 2, digital combiner 145 and 270 digitally combines M coarse bits Dc and N fine bits Df to generate digital output DOUT 165, which is a digital representation of input signal VIN 160.

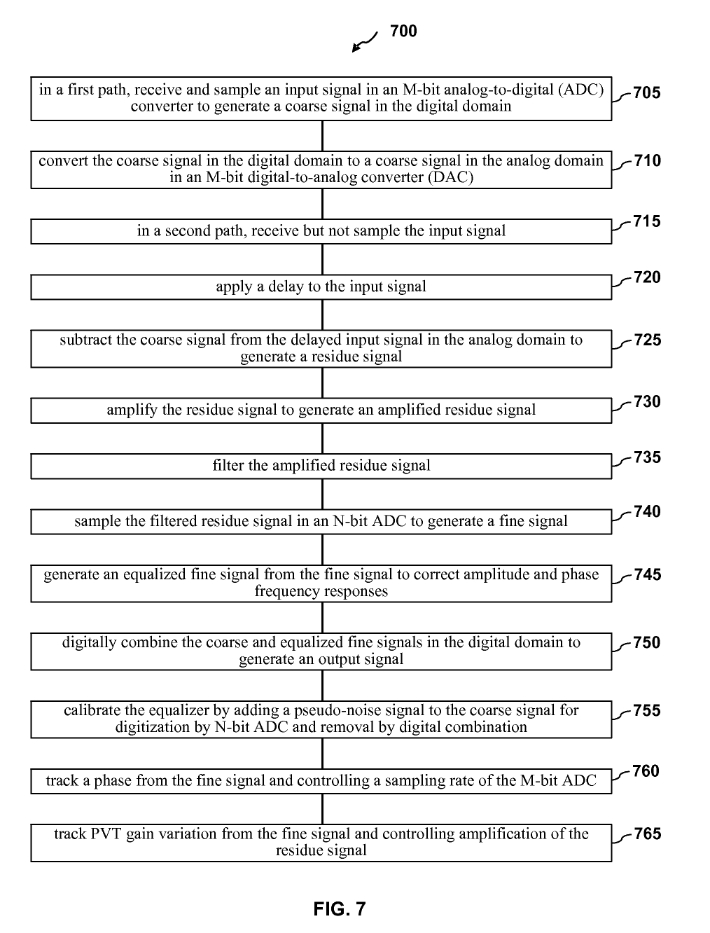

One of many detailed embodiments of the method in FIG. 600 is shown in FIG. 7. FIG. 7 shows a flowchart 700 of an exemplary embodiment of a process for converting an analog signal into a digital signal in a direct sampling receiver with a CT MDAC. Embodiments described with respect to FIGS. 1-5 and other embodiments in accordance with the technical subject matter described herein may operate according to flowchart 700.

Flowchart 700 comprises steps 705 to 765, which may be performed in a continuous operation. However, other embodiments may operate in other ways. Other structural and operational embodiments will be apparent to persons skilled in the relevant art(s) based on the foregoing discussion of embodiments. No order of steps is required unless expressly indicated or inherently required. There is no requirement that a method embodiment implement all of the steps illustrated in FIG. 7. FIG. 7 is simply one of many possible embodiments. Embodiments may implement fewer, more or different steps. Flowchart 700 is described as follows.

Flowchart 700 begins with step 705. In step 705, in a first path an input signal is received and sampled in an M-bit analog-to-digital (ADC) converter to generate a coarse signal in the digital domain. For example, as shown in FIG. 2, input signal VIN 160 may be sampled by M-bit ADC 210 in the quantizer path to generate M coarse bits Dc.

At step 710, the coarse signal in the digital domain is converted to a coarse signal in the analog domain in an M-bit digital-to-analog converter (DAC). For example, as shown in FIG. 2, in the quantizer path, M coarse bits Dc is converted into a coarse analog signal M-bit DAC 230.

At step 715, in a second path, the input signal is received but not sampled. For example, as shown in FIGS. 1 and 2, input signal VIN 160 is received in the CT path, but is not sampled (e.g., is received by delay 225 in FIG. 2).

At step 720, a delay is applied to the input signal. For example, as shown in FIG. 2, analog delay 225 is applied to analog input signal VIN 160.

At step 725, the coarse analog signal is subtracted from the delayed input signal in the analog domain to generate a residue signal. For example, as shown in FIG. 2, residue signal calculator 235 subtracts analog coarse signal VC from the delayed input signal to generate residue signal VR.

At step 730, the residue signal is amplified to generate an amplified residue signal. For example, as shown in FIG. 2, residue signal VR is amplified with 2^{K} gain by amplifier 240 to generate an amplified residue signal.

At step 735, the amplified residue signal is filtered. For example, as shown in FIG. 2, filter 245 filters the amplified residue signal.

At step 740, the filtered residue signal is sampled in an N-bit ADC to generate a fine signal. For example, as shown in FIG. 2, N-bit ADC 260 samples the filtered residue signal to generate N fine bits Df.

At step 745, an equalized fine signal is generated from the fine signal to correct amplitude and phase frequency responses. For example, as shown in FIG. 2, equalizer 365 generates an equalized fine signal from N fine bits Df to correct amplitude and phase frequency responses as desired.

At step 750, the coarse and equalized fine signals are digitally combined to generate a digital representation of the input signal. For example, as shown in FIG. 2, digital combiner 270 digitally combines M coarse bits Dc and equalized N fine bits to generate digital output DOUT 165, which is a digital representation of input signal VIN 160.

At step 755, the equalizer is calibrated by adding a pseudo-noise signal to the coarse signal for digitization by N-bit ADC and removal by digital combination. For example, as shown in FIG. 2, PNGEN 305 generates noise PN, and noise injector 320 injects the generated noise PN into M coarse bits Dc, which results in re-digitization of noise PN by N-bit ADC 260 and removal of noise PN by digital combiner 270.

At step 760, a phase from the fine signal is tracked and a sampling rate of the M-bit ADC is controlled. For example, as shown in FIG. 2, phase tracker 355 tracks a phase of N-fine bits Df. Phase rotator 315 receives a tracked phase indication signal from phase tracker 355, and uses tracked phase information included in the tracked phase indication signal to control the sampling time of M-bit ADC 210. For instance, in this manner, phase rotator 315 may cause M-bit ADC 210 to sample input signal VIN 160 slightly sooner or later in order to minimize the fine ADC input power, and thereby minimizing an aperture error.

At step 765, PVT gain variation is tracked from the fine signal and an amplification of the residue signal is controlled. For example, as shown in FIG. 2, gain control 350 tracks PVT variation from N fine bits Df and controls the gain of amplifier 240 applied to residue signal VR. The gain of amplifier 240 may be increased or decreased based on variations in PVT that cause gain variation detected in N fine bits Df.

In embodiments where a plurality of ADCs operate according to flowchart 600 or 700 as a plurality of channels, flowchart 600 and/or 700 may further comprise combining digital output DOUT 165 data with digital output from at least one other channel operation of the method. In some embodiments, continuous background calibration may be performed.

### VII. Conclusion

A device (i.e., apparatus), as defined herein, is a machine or manufacture as defined by 35 U.S.C. §101. Devices may be digital, analog or a combination thereof. Some devices may be implemented with a semiconductor process or semiconductor technology, including one or more of a Bipolar Junction Transistor (BJT), a heterojunction bipolar transistor (HBT), a metal oxide field effect transistor (MOSFET) device, a metal semiconductor field effect transistor (MESFET) or other transconductor or transistor technology device. Such alternative devices may require alternative configurations other than the configuration illustrated in embodiments presented herein.

Techniques, including methods, described herein may be implemented by hardware (digital and/or analog) or a combination of hardware with software and/or firmware. Techniques described herein may be implemented by one or more components. Embodiments may comprise computer program products comprising logic (e.g., in the form of program code or software as well as firmware) stored on any computer useable medium, which may be integrated in or separate from other components. Such program code, when executed in one or more processors, causes a device to operate as described herein. Devices in which embodiments may be implemented may include storage, such as storage drives, memory devices, and further types of computer-readable storage media. Examples of such computer-readable storage media include, but are not limited to, a hard disk, a removable magnetic disk, a removable optical disk, flash memory cards, digital video disks, random access memories (RAMs), read only memories (ROM), and the like. In greater detail, examples of such computer-readable storage media include, but are not limited to, a hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may, for example, store computer program logic, e.g., program modules, comprising computer executable instructions that, when executed, provide and/or maintain one or more aspects of functionality described herein with reference to the figures, as well as any and all components, steps and functions therein and/or further embodiments described herein.

Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as signals transmitted over wires. Embodiments are also directed to such communication media.

Proper interpretation of subject matter described herein and claimed hereunder is limited to patentable subject matter under 35 U.S.C. §101. Subject matter described in and claimed based on this patent application is not intended to and does not encompass unpatentable subject matter. As described herein and claimed hereunder, a method is a process defined by 35 U.S.C. §101. As described herein and claimed hereunder, each of a circuit, device, apparatus, machine, system, computer, module, media and the like is a machine and/or manufacture defined by 35 U.S.C. §101.

While various embodiments have been described above, it should be understood that they have been presented by way of example only, and not limitation. Embodiments are not limited to the functional blocks, detailed examples, steps, order or the entirety of subject matter presented in the figures, which is why the figures are referred to as exemplary embodiments. A device, apparatus or machine may comprise any one or more features described herein in any configuration. A method may comprise any process described herein, in any order, using any modality. It will be understood by those skilled in the relevant art(s) that various changes in form and details may be made to such embodiments without departing from the spirit and scope of the subject matter of the present application.

The exemplary appended claims encompass embodiments and features described herein, modifications and variations thereto as well as additional embodiments and features that fall within the true spirit and scope of the disclosed technologies. Thus, the breadth and scope of the disclosed technologies should not be limited by any of the above-described exemplary embodiments or the following claims and their equivalents.

What is claimed is:

1. A device comprising:
a first signal path configured to receive and sample an input signal and generate a coarse signal;
a second signal path configured to receive but not sample the input signal, subtract the coarse signal from the input signal in the analog domain to generate a residue signal and sample the residue signal to generate a fine signal; and
a digital combiner configured to combine the coarse and fine signals in the digital domain to generate an output signal.

2. The device of claim 1, wherein the first signal path comprises an M-bit analog-to-digital converter (ADC) to generate the coarse signal in the digital domain and an M-bit digital-to-analog converter (DAC) to generate the coarse signal in the analog domain.

3. The device of claim 2, wherein the first signal path further comprises a phase rotator to generate a variable sampling phase for the M-bit ADC, wherein the phase rotator is controlled by a phase tracking loop from the fine signal.

4. The device of claim 1, wherein the second signal path comprises an N-bit analog-to-digital converter (ADC) to generate the fine signal in the digital domain.

5. The device of claim 4, wherein the second signal path comprises an analog delay applied to the input signal before subtracting the coarse signal from the input signal.

6. The device of claim 5, wherein the second signal path comprises an amplifier configured to amplify the residue signal to generate an amplified residue signal.

7. The device of claim 6, wherein the amplifier gain is controlled by a gain control loop from the fine signal.

8. The device of claim 7, wherein the second signal path further comprises a filter configured to filter the amplified residue signal before the N-bit ADC sampling the amplified residue signal to generate the fine signal.

9. The device of claim 8, wherein the second signal path further comprises an equalizer to generate an equalized fine signal from the fine signal, the digital combiner configured to combine the coarse signal and equalized fine signal in the digital domain to generate the output signal.

10. The device of claim 4, wherein sampling rates of the M-bit ADC and the M-bit DAC are greater than a sampling rate of the N-bit ADC.

11. The device of claim 1, further comprising:
a pseudo random noise generator configured to generate a noise signal, the noise signal added to the coarse signal in the digital domain before conversion to the analog domain and subtraction from the input signal, the noise signal being removed by the digital combiner.

12. The device of claim 11, wherein the pseudo random noise generator is configured to generate a noise signal to calibrate the equalizer to compensate the amplitude and phase responses of the second signal path.

13. A method comprising:
in a first signal path:
receiving and sampling an input signal in an M-bit analog-to-digital (ADC) converter to generate a coarse signal in the digital domain, and
converting the coarse signal in the digital domain to a coarse signal in the analog domain in an M-bit digital-to-analog converter (DAC); and
in a second signal communication path:
receiving but not sampling the input signal,
subtracting the coarse signal from the input signal in the analog domain to generate a residue signal, and
sampling the residue signal in an N-bit ADC to generate a fine signal; and
digitally combining the coarse and fine signals in the digital domain to generate an output signal.

14. The method of claim 13, further comprising:
tracking a phase from the fine signal and controlling a sampling phase of the M-bit ADC.

15. The method of claim 13, further comprising:
applying a delay to the input signal before subtracting the coarse signal from the input signal.

16. The method of claim 15, further comprising:
amplifying the residue signal to generate an amplified residue signal; and
controlling the amplifier gain by a gain control loop from the fine signal.

17. The method of claim 16, further comprising:
filtering the amplified residue signal, the N-bit ADC sampling the amplified residue signal to generate the fine signal.

18. The method of claim 17, further comprising:
generating, by an equalizer, an equalized fine signal from the fine signal, the digital combiner combining the coarse signal and equalized fine signal in the digital domain to generate the output signal.

19. The method of claim 18, further comprising:
calibrating the equalizer by adding a pseudo-noise signal to the coarse signal and
removing the pseudo-noise signal during the digital combination.

20. A device comprising:
an analog-to-digital converter (ADC) that converts an analog signal into a plurality of bits, the ADC comprising:
a coarse ADC that samples the analog signal to generate a coarse bit in the plurality of bits;
a fine ADC that samples a residue of the analog signal instead of the analog signal to generate a fine bit in the plurality of bits; and
a digital combiner that combines the coarse and fine signals to generate a digital representation of the analog signal.
